(19) United States
(12) Patent Application Publication
(10) Pub. No.: US 2008/0127767 A1
(43) Pub. Date: Jun. 5, 2008

(54) Shifting Device of a Manual Gearbox For a Motor Vehicle

(75) Inventor: Uwe Beer, Fahrland (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen AG (DE)

(21) Appl. No.: 11/792,974

(22) PCT Filed: Nov. 29, 2005
(86) PCT No.: PCT/EP05/12712

§ 371 Date: Jun. 13, 2007

(30) Foreign Application Priority Data
Dec. 14, 2004 (DE) 102004060056.2

(51) Int. Cl. F16H 61/24; F16H 63/38

(52) U.S. Cl. 74/473.21; 74/473.1

(57) ABSTRACT

A shift device in a manual transmission of a motor vehicle having a central selector shaft (6) with two rocker arms (7, 8) to which a spindle (9) is supported. The spindle (9) supports a roller (10), which communicates with a pivotally mounted, spring-loaded contour element (2). The contour element (2) has a gate guide which extends in a circular arc (k) concentric with the selector shaft (6). The rocker arms (7, 8) have guide pins (19) which extend parallel to the selector shaft (6) on a radius (R) of the circular arc (k). The guide pins (19) are moveable through axially directed movement of the selector shaft (6) to engage the gate guide.

This application is a national stage completion of PCT/EP2005/012712 filed Nov. 29, 2005 which claims priority from German Application Serial No. 10 2004 060 056.2 filed Dec. 14, 2004.

### FIELD OF THE INVENTION

The invention pertains to a shift device with a central selector shaft in a manual transmission of a motor vehicle.

### BACKGROUND OF THE INVENTION

Drivers operate manual transmissions of motor vehicles by means of a shift lever, which from its resting position is moved in a so-called cross track and in several shift tracks (perpendicular to the cross track). The shifting procedure therefore consists, on the one hand, of a transverse movement of the shift lever, the selection and the shifting movements are perpendicular to each other. With the selection movement, a gear change sleeve is selected in the transmission, and with the shift movement, the respective gear is positioned in the power flow. In order to assist the driver in his shift movement and to provide him with a sense of the current shift lever position, selection- or shift forces are generated within the transmission, which counteract the driver's shift movements to a greater or lesser degree.

According to DE 102 29 320 A1, upon which the invention is based, a shift device for the generation of a power selection process by a contour element has become known. The contour element is rotatable inside a gearbox, which is in mesh with a roller, which is fastened to a central selector shaft by rocker arms. During the rotation of the selector shaft, which corresponds to the selection movement, a selection force process is thus generated, which can be influenced by the contour of the contour element.

According to DE 100 16 364 A1 a selection and shift module for a manual transmission has become known, in which due to the interaction of various springs, a coil spring and a leg spring, various selection forces are generated. The driver is thus assisted in his shift movement and has a sense of the shift track in which the shift lever is positioned, especially when selecting the reverse gear.

According to the applicant's DE 40 20 160 A1 another shift device with a central selector shaft with a selector rocker has become known, through which selector forces in interaction with spring elements are generated, whereby through the selector rocker, during a selection move, various compression springs and a leg spring are adjusted.

The above state of the art demonstrates that for the generation of selection force, special devices are always provided for manual transmissions. Additionally, shift devices may also have gate guides for selector shafts, which present the typical H-pattern for manual transmissions.

### SUMMARY OF THE INVENTION

It is the purpose of the present invention to improve a shift device of the previously mentioned type with respect to its function and at the same time reducing the number of components as well as the production costs for the entire transmission.

According to the invention, it is intended that the contour element, for the generation of a power selection process, also assume the function of a gate guide during the selection and shift movement. For this, guide pins are additionally provided on the rocker arms, which interact with the gate guide that is positioned in the contour element and thus engage in positions relative to the individual shift tracks. This provides the advantage that the contour element in connection with the rocker arms at the central selector shaft in addition to the selection force generation also creates a gate guide, for which, according to the prior art, a separate device is required, which is connected to additional components. The invention-related combination of both functions results with regard to the complete transmission in a building space improvement, a lower number of components and lower production costs.

According to a beneficial arrangement of the invention, the gate-type guide is formed by recesses assigned to the shift tracks, into which the guide pins engage and are thus fixed for the respective shift track. It is preferred that between the recesses angular faces are positioned, which perform a track deflection function. Thus achieving the benefit that the guide pins in the selection movement are always guided into a recess. The shift lever's classic H-pattern can therewith be reproduced with the gate guide of the invention. The guide pins are beveled and conically shaped at their end surfaces in order to improve the deflection function.

In another beneficial arrangement of the invention, the contour element is designed as a stamped and embossed component, i.e. the outer contours and the recesses are stamped from a tin card while the beveled edges between the recesses are shaped, which can be done in one operation. With this, the advantage of lower production costs is achieved.

According to a beneficial improvement of the invention, the gate-type guide is configured as a continuous slotted contour, wherein circular extensions form the locking positions for the respective shift tracks, and between the extensions restrictions for the slotted contour are provided. This gate-type guide configuration has the benefit that the entire contour element can be produced as a complete stamped component. The restrictions formed as two-dimensional contours thus assume the track deflection function.

In another beneficial arrangement of the invention, stops for the selection as well as for the shift movement are provided at the contour element and/or at the rocker arms. This results in additional benefits with respect to building space as well as the number of components.

### BRIEF DESCRIPTION OF THE DRAWINGS

Exemplary embodiments of the invention are illustrated in the diagrams and will be further clarified below. The diagrams show:

FIG. 1 a first exemplary embodiment of a shift device with contour element according to the invention;

FIG. 2 a cross-section along line II-II;

FIG. 3 a plan view of the shift device with a partial cross-section along line III-III;

FIG. 4 a second exemplary embodiment of a shift device with a modified gate guide and

FIG. 5 a plan view of the shift device as well as a partial cross-section along line V-V.

### DETAILED DESCRIPTION OF THE INVENTION

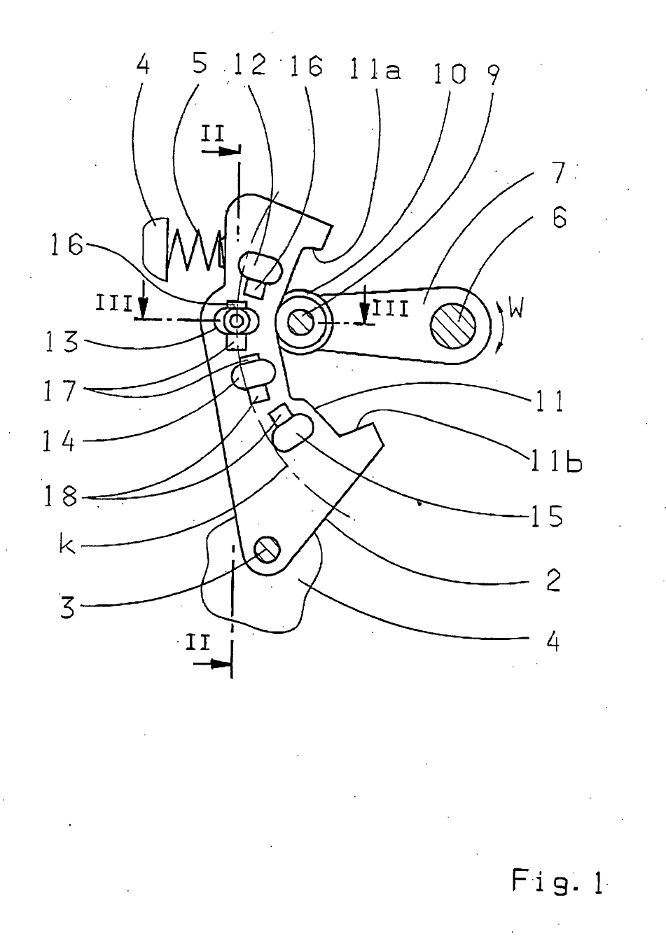

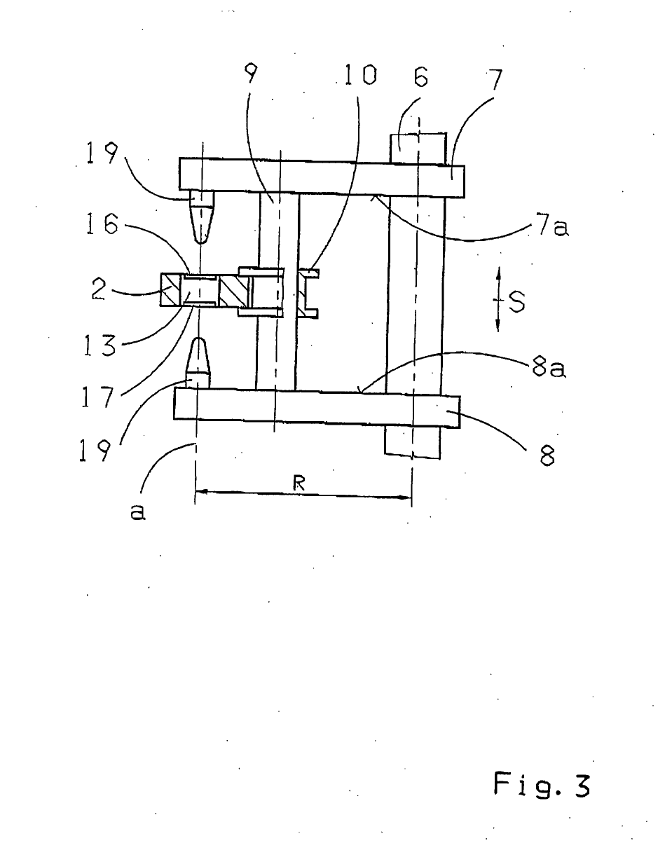

FIG. 1 shows a detail of a shift device 1 with a contour element 2, which is pivotable around a case-fixed trunnion 3, yet is positioned axially fixed in a gear case 4, and with its end, which is opposite from the trunnion 3, is supported against the case, 4 via a spring element 5. On a central selector shaft 6 two rocker arms 7, 8 (see also FIG. 3) are affixed, between which, parallel to the central selector shaft 6, a spindle 9 with a rotatable roller 10 is positioned. The contour element 2 has a contour 11, which is in contact with the roller 10 and is configured according to a selected power selection process, as is further described in the type-defining publication, the applicant's DE 102 29 320 A1. The contour 11 is limited on both sides by protrusions 11a and 11b, which during the selection movement function as stops. One rotation of the selector shaft 6 around its longitudinal axis thus corresponds to the selection movement, illustrated by a double arrow W. During the selection movement—as previously mentioned—a shift lever (not illustrated) is moved in a cross track (not illustrated) for selection of a shift track. The described shift device 1 is part of a manual transmission for motor vehicles, not shown here, and thus is known.

According to the invention, oblong formed recesses 12, 13, 14 and 15, which are positioned intermittently to each other on an approximately circular arc k around the axis of the selector shaft 6, as well as the not illustrated shift tracks, are positioned in the contour element 2. Beveled areas 16, 17 and 18, so-called diagonal shift bevels, with track-deflection function, are positioned between the recesses 12, 13, 14 and 15.

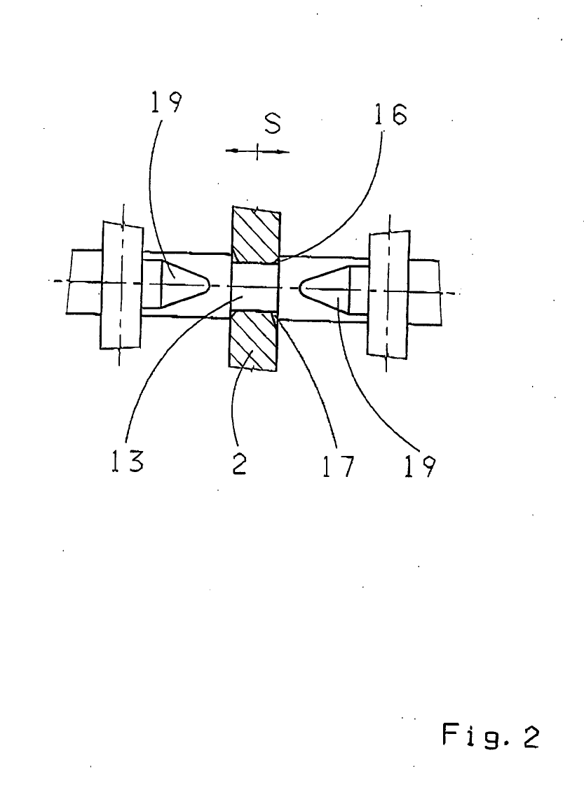

FIG. 2 shows a partial cross-section along section line II-II through the contour element 2 in the area of the recess 13. On both sides of the recess 13 in the direction of selection and on both sides of the contour element 2, beveled areas 16, 17 are positioned, which are preferably embossed into the contour element 2. The contour element 2 can thus be produced as a stamped and embossed component.

FIG. 3 shows a plan view of the selector shaft 6 with both rocker arms 7, 8 as well as a partial cross section along section line III-III in FIG. 1. The rocker arms 7, 8 are extend past the spindle 9 and have, at their ends, two guide pins 19, which are directed toward the inside, i.e. in the direction of the contour element 2. The guide pins 19 are formed conically and beveled on their end surfaces; they are positioned on the same axis a, which runs through the recess 13 of the contour element 2 and at a distance R parallel to the longitudinal axis of the selector shaft 6, wherein R is equal to the radius of the circular arc k in FIG. 1. The shift movement of the selector shaft 6 in a longitudinal direction is illustrated by a double arrow S. The illustration shows that during a movement of the selector shaft 6 in the direction of arrow S, one of the two guide pins 19 can be moved to mesh with the recess 13. The rocker arms 7, 8 during the shift movement form shift stops with their interior surfaces 7a, 8a. In FIG. 2 the shift movement is also illustrated by a double arrow S, wherein it is noticeable that the guide pins 19 come into sliding contact with the beveled areas 16, 17 during the selection movement.

The function of the shift device 1 is as follows: During the selection movement according to double arrow W, the rocker arms 7, 8 are pivoted upward or downward out of the resting position (neutral position) illustrated in FIG. 1. The roller 10 thereby rolls onto the contour 11 of the contour element 2, whereas due to the support of the spring element 5, a selection force is generated. As mentioned, the selection movement W is equal to a transverse movement by the shift lever in the cross track of an H-shift pattern for the selection of a shift track. The recesses in the contour element 2 are always assigned to a shift track, namely the uppermost recess 12 to shift track 5/6, the adjacent recess 13 to shift track 3/4 and the neutral position, the recess 14 to shift track 1/2 and the recess 15 to the shift track for the reverse gear. In the selection movement, i.e. the tilt-out of the rocker arms 7, 8, the guide pins are no longer in mesh, i.e. in the position illustrated in FIGS. 2 and 3 they are outside of the contour element 2. Following the completion of the selection process, the shift movement is initiated by a longitudinal movement of the selector shaft 6 according to double arrow S, so that one of the two guide pins 19 engages in one of the recesses 12 through 15. A not-illustrated selected gear change sleeve is thus moved axially and the affected gear wheel for the selected gear is shifted into the power flow. The selection stops 11a, 11b on the contour element 2 form a limitation for the swivel movement of rocker arms 7, 8 and/or the not-illustrated shift lever in the cross track during the selection movement. However the shift movement is limited by the shift stops 7a, 8a.

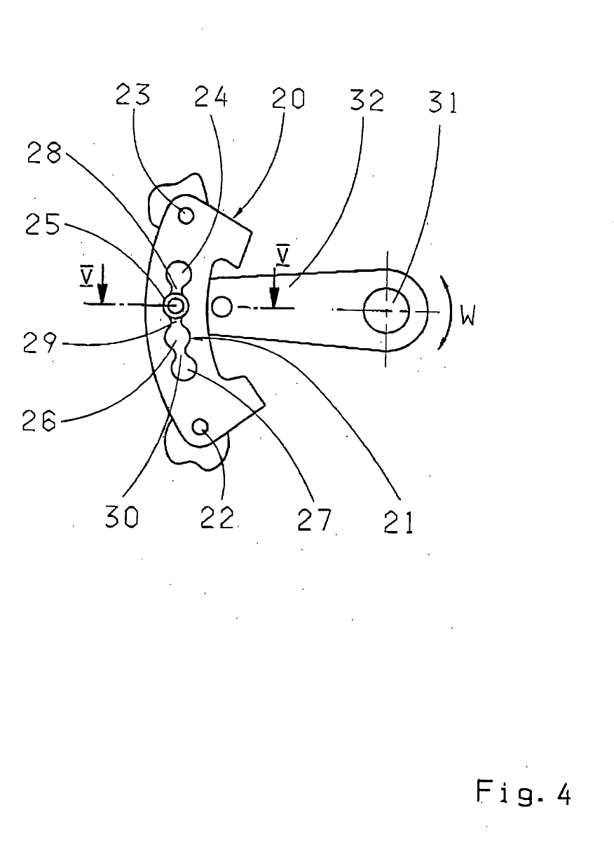

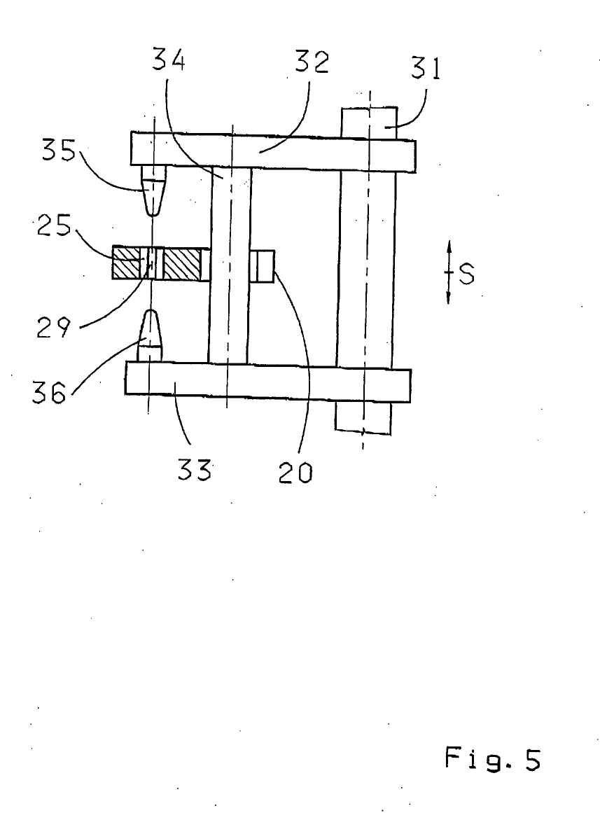

FIG. 4 shows a second exemplary embodiment of the invention in hand with a contour element 20, which has a modified gate guide in the form of a continuous, closed slotted contour 21. The contour element 20, in the following referred to as gate element 20, is here strictly formed as a gate and affixed to the case at two points, via trunnions 22, 23. The slotted contour 21 has four roughly circular shaped extensions 24, 25, 26, 27 as well as constrictions 28, 29, 30, which are aligned between them. The extensions 24 through 27 are assigned to the above-mentioned shift tracks; the constrictions 28 through 30 assume the track deflection function. In the drawing, to the right of the gate element 20—analogous to the previous embodiment—a central selector shaft 31 is arranged with attached support rockers 32, 33 (cf. FIG. 5).

FIG. 5 shows a plan view of the support rockers 32, 33, which are connected through a rod 34, which is arranged parallel to the selector shaft 31. At the ends of the support rockers 32, 33, which are opposite from the selector shaft 31, the guide pins 35, 36—analogous to the previous exemplary embodiment—are arranged on both sides of the gate element 20. The gate element 20 is sectioned according to the sectional plane V-V, i.e. in the area of extension 25. The roughly circular extensions 24 through 27 are equal to the diameters of gate pins 35, 36 and positively receive them in a corresponding shift movement in the direction of the double arrow S. The constrictions 28 through 30 between the extensions 24 through 27 function as deflectors and prevent a shift movement in this area. Thus they assume in analogous form the function of the beveled areas 16 through 18 according to the first exemplary embodiment. The benefit of the continuous two-dimensional slotted contour 21 is found in a more advantageous production. The gate element 20 can be produced strictly as a stamped component, i.e. without an additional embossing process.

### REFERENCE SYMBOLS

1 shift device
2 contour element
3 trunnion
4 case
5 spring element
6 selector shaft
7 rocker arm
7a shift stop
8 rocker arm
8a shift stop
9 spindle
10 roller
11 contour
11a selector stop
11b selector stop
12 recess (5/6)
13 recess (3/4)
14 recess (1/2)
15 recess (R)
16 bevel pair
17 bevel pair
18 bevel pair
19 gate pin
20 contour element (gate element)
21 slotted contour
22 trunnion
23 trunnion
24 extension
25 extension
26 extension
27 extension
28 constriction
29 constriction
30 constriction
31 selector shaft
32 support rocker
33 support rocker
34 rod
35 guide pin
36 guide pin

1-12. (canceled)

13. A shift device in a manual transmission of a motor vehicle, the shift device comprising:
two rocker arms (7, 8) fixed to a central selector shaft (6, 31), and the two rocker arms (7, 8) support a spindle (9);
a roller (10) being supported by the spindle (9) and engaging a pivotally mounted, spring-loaded contour element (2);
the contour element (2) having a gate guide, which extends in a circular arc (k) concentric with the selector shaft (6);
the rocker arms (7, 8) have guide pins (19), which extend parallel to the selector shaft (6) at a radius (R) of the circular arc (k), and the guide pins (19) being movable, with respect to axial movement of the selector shaft (6), to engage the gate guide.

14. The shift device according to claim 13, wherein the gate guide comprises a plurality of recesses (12, 13, 14, 15).

15. The shift device according to claim 14, wherein the plurality of recesses (12, 13, 14, 15) are oblong with a longer length thereof extending in a direction of the selector shaft (6).

16. The shift device according to claim 14, wherein the plurality of recesses (12-15) have beveled areas (16, 17, 18) therebetween, and the beveled areas (16, 17, 18) are positioned in at least one of a direction of selection movement and a direction of swivel of the guide pins (19).

17. The shift device according to claim 13, wherein the contour element (2) is a stamped and embossed component.

18. The shift device according to claim 13, wherein the gate guide has a open slotted contour (21) that extends along the circular arc (k) and has flarings (24, 25, 26, 27) and constrictions (28, 29, 30).

19. The shift device according to claim 18, wherein the contour element (20) is a stamped component.

20. The shift device according to claim 13, wherein the guide pins (19) have end faces that are at least one of rounded and beveled.

21. The shift device according to claim 14, wherein at least one of the plurality of recesses (12, 13, 14, 15) and the flarings (24, 25, 26, 27) form locking positions for a selected shift track.

22. The shift device according to claim 16, wherein at least one of the beveled areas (16, 17, 18) and the constrictions (28, 29, 30) deflect the guide pins (19; 35, 36).

23. The shift device according to claim 13, wherein the contour element (2) has protrusions (11a, 11b) which limit selection movement of the shift device.

24. The shift device according to claim 13, wherein the rocker arms (7, 8) have inner areas (7a, 8a) which form shift stops to limit shift movement of the shift device.
